(19) United States
(12) Patent Application Publication
(10) Pub. No.: US 2011/0084213 A1
(43) Pub. Date: Apr. 14, 2011

(54) Organic Radiation Monitoring Device

(76) Inventors: Randall Boudouris, Auburn Hills, MI (US); Donald E. Albrecht, Roseville, MN (US); Stephen J. Papadimos, Sylvania, OH (US)

(21) Appl. No.: 12/578,026

(22) Filed: Oct. 13, 2009

(51) Int. Cl. G01T 1/02; B32B 7/12

(52) U.S. Cl. 250/395; 428/355 R; 250/472.1

(57) ABSTRACT

A label assembly for the detection of high energy radiation, the assembly including at least one substrate layer having a first surface and a second surface opposite the first surface, at least one self-adhering layer disposed on said first surface of said substrate layer and at least one indicator for exposure to high energy radiation.

### FIELD OF THE INVENTION

The present invention relates to the detection of high energy radiation, and to a device and method therefore.

### BACKGROUND OF THE INVENTION

It is becoming increasingly important to monitor ionizing radiation to determine nuclear fallout such as from the use of nuclear weapons, for monitoring the escape of radioactive species from nuclear power plants, and to determine if goods have been subjected to sufficient radiation when being sterilized by ionizing radiation.

Ionizing radiation refers to radiation having of sufficient energy to displace electrons from their orbits around the nuclei and hence to produce positively charged ions.

Gamma radiation is a form of ionizing radiation, as well as hard x-rays, electron beams and cosmic radiation. Gamma rays are high-energy electromagnetic radiation produced by nuclear transitions, while X-rays are high-energy electromagnetic radiation produced by energy transitions due to accelerating electrons. Because it is possible for some electron transitions to be of higher energy than some nuclear transitions, there is an overlap between what we call low energy gamma rays and high energy X-rays.

Gamma radiation typically has an energy beginning at about 10 keV/2.42 EHz/124 pm.

There are a variety of apparatuses which have been disclosed for detection of high energy radiation.

For example, U.S. Pat. No. 4,001,587 discloses a color indicator-dosimeter of ionizing radiation comprising 70 to 100 parts by weight of a thermoplastic polymer, 10 to 40 parts by weight of a plasticizer, 0.5 to 3.0 parts by weight of a stabilizer and two dyes compatible with said polymer. The proposed indicator-dosimeter enables radiation doses to be visually (by color) and objectively (with the aid of a spectrophotometer) determined.

U.S. Pat. No. 4,494,003 discloses a method of detecting gamma radiation by placing glass doped with iron in an environment subject to gamma radiation and then measuring any color changed in the doped glass as a function of gamma radiation.

U.S. Pat. No. 5,084,623 discloses a multi-ply radiation dosage indicator including a first ply having visible indicia thereon and a second ply having a radiation sensitive zone overlying the indicia of the first ply. The radiation sensitive zone is capable of changing opacity in response to exposure to a radiation dosage exceeding a predetermined threshold so as to change the visibility of the indicia thereby providing an indication as to whether the indicator has become irradiated. An optical filter ply may be provided overlying the indicia, and the indicator also may be provided with a transparent protective outer ply. A pressure sensitive adhesive ply having a removable release sheet is employed for attaching the indicator to a substrate.

U.S. Pat. No. 6,232,610, discloses a dosimeter analysis system capable of handling easily the radiochromic pieces of film which are commonly employed as dosimeters and make an accurate analysis of the amount of radiation received in an irradiation process, such as during irradiation of food.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### SUMMARY OF THE INVENTION

There remains a need in the art for a simple, inexpensive, device which can quickly and easily detect the presence of high energy radiation, as well as a device which is easy and inexpensive to manufacture. Furthermore, there remains a need in the art for a device which can not only detect the high energy radiation, but which can broadcast a signal indicating that the high energy radiation has been detected.

The present invention relates to a device for the detection of high energy radiation, the device including at least one substrate layer having a first surface and a second surface opposite the first surface, at least one self-adhering layer disposed on said first surface of said substrate layer and at least one indicator for exposure to high energy radiation.

In one embodiment, the pressure sensitive adhesive is disposed on a first surface of the at least one first substrate and the radiation sensitive composition is disposed on a second surface which is opposite that of the first surface.

In one embodiment, the at least one indicator for exposure to high energy radiation is applied as a coating layer to at least one surface of the at least one substrate layer.

In one embodiment, the radiation detection device is a label including at least one first substrate, a radiation sensitive composition and a pressure sensitive adhesive.

In another embodiment, the radiation detection device is a label assembly including at least one first substrate, at least one radiation sensitive layer, and at least one pressure sensitive adhesive layer applied the at least one first substrate on a surface which is opposite that of the at least one radiation sensitive layer.

In this embodiment, a release liner may also be applied to the pressure sensitive adhesive layer.

Any type of pressure sensitive adhesive may be employed herein. In any of the embodiments described, the adhesive may be a removable or semi-permanent grade pressure sensitive adhesive. For some applications, a permanent grade pressure sensitive adhesive may be desirable.

In any of the embodiments, the adhesive may be a hot melt adhesive, water-based adhesive, or a reactive or thermosetting adhesive including, for example, hot melt moisture cures, one and two-part systems such as polyurethanes and epoxies, polysulfides, cyanoacrylates, heat curing polyurethanes, radiation cures such as UV curable adhesives and electron or e-beam curable adhesives, etc.

In another embodiment, the label assembly includes at least one first substrate, at least one radiation sensitive layer, and at least one magnetic layer which is applied to the substrate surface which is opposite that surface to which the radiation sensitive layer is applied.

In some embodiments, the radiation sensitive composition undergoes an optical change upon exposure to high energy radiation. For example, refractive index of some materials or fibers may change upon exposure to gamma radiation.

In some embodiments, the radiation sensitive composition changes color upon the absorption of high energy radiation.

In one embodiment, the radiation sensitive composition includes a radiation-sensitive dye or pigment. The dye changes color upon exposure to high energy radiation.

In some embodiments, the radiation sensitive composition undergoes a change in its molecular structure upon exposure to high energy radiation.

Optionally, a coating, film, varnish, etc., may be applied over the radiation sensitive layer and the substrate to provide a protective layer.

Other optional features may be incorporated into the label assembly such as tamper evident features, authenticating indicia to provide evidence of counterfeiting, etc.

The label may also be optionally provided with radio frequency identification (RFID) technology which is triggered by a radiation sensor when the label is exposed to high energy radiation. The RFID insert further sends out a signal indicating radiation exposure.

These and other aspects, embodiments and advantages of the present invention will be apparent to those of ordinary skill in the art upon review of the Detailed Description and Claims to follow.

### BRIEF DESCRIPTION OF THE DRAWINGS

FIG. 1 is a side view of one embodiment of a label assembly for the detection of high energy radiation according to the invention.

FIG. 2 is a side view of a label assembly similar to that shown in FIG. 1, showing a peel-away layer.

FIG. 3 is a perspective view of a label assembly disposed on a surface after peel-away layer has been completely removed.

FIG. 4 is a perspective side view of a label assembly according to the invention further including a tamper-evident grid.

FIG. 5 is a perspective side view of a label assembly similar to that shown in FIG. 4 illustrating a severed grid.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

All published documents, including all US patent documents, mentioned anywhere in this application are hereby expressly incorporated herein by reference in their entirety. Any copending patent applications, mentioned anywhere in this application are also hereby expressly incorporated herein by reference in their entirety.

For the purposes of this disclosure, like reference numerals in the figures shall refer to like features unless otherwise indicated.

Depicted in the figures are various aspects of the invention. Elements depicted in one figure may be combined with, or substituted for, elements depicted in another figure as desired.

The present invention relates to a label assembly for detecting high energy radiation. High energy radiation includes, for example, alpha, beta and gamma radiation, as well as neutrons, and hard x-rays. The label assembly includes at least one substrate layer, at least one radiation indicator, and at least one self-adhering layer such as a tacky adhesive layer or a magnetic layer. The choice of which type of self-adhering layer may be employed, may depend on the surfaces to which the label will be adhered, for example, and whether or not a permanent bond is desired between the label assembly and the surface, or whether a temporary bond is acceptable. Of course, in the latter case, semi-permanent or removable grade pressure sensitive adhesives may be employed in formation of the self-adhering layer, as well as a magnetic composition.

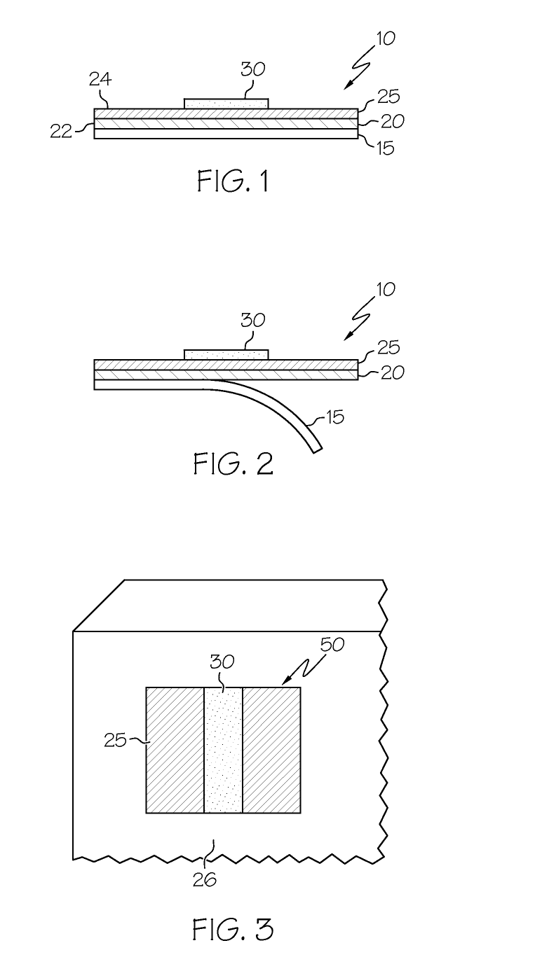

Turning now to the figures, FIG. 1 is a perspective view of one embodiment of a label assembly according to the invention. In this embodiment, self-adhering layer 20 is a tacky adhesive layer and is disposed on a first surface 22 of a first substrate layer 25. First substrate layer may be formed of any suitable substrate material. Suitably, a polymer film such as polyester is employed. A radiation sensitive coating 30 is applied to a second surface 24 of the first substrate layer 25 which is opposite that of the first surface 22. Radiation sensitive coating 30 is shown on only a portion of substrate layer 25, but may be applied to the entire substrate layer 25 as well.

A release liner 15 is shown disposed on tacky adhesive layer 20. Upon use, release liner 15 is peeled away from tacky adhesive layer 20 as shown in FIG. 2. The tacky adhesive layer 20, suitably formed from a pressure sensitive adhesive, and even more suitably a permanent grade pressure sensitive adhesive, may then be brought in contact with a surface 22, to which it is desired that the label be applied, as shown in FIG. 3. The label assembly may be applied to any desirable surface including, for example, but not limited to, walls, doors, ceilings, furniture, appliances, floors, countertops, etc.

The radiation sensitive coating may incorporate any suitable component which exhibits sensitivity to high energy radiation, for example, alpha, beta and gamma radiation, as well as neutrons and hard x-rays.

The self-adhering layer may be formed from either an adhesive composition, or may be formed from a magnetic composition such as of the type described in US Patent Publication 2002-0081446 A1, the entire content of which is incorporated by reference herein in its entirety.

Any type of pressure sensitive adhesive may be employed herein. Suitably, the adhesive employed herein is a removable or semi-permanent grade pressure sensitive adhesive, although permanent grade pressure sensitive adhesives may find utility herein as well. For some applications, freezer grade and all-temperature grades may find utility as well. For example, the latter grades may be selected for use in places where it is necessary to keep the temperature low, or for outdoor use. Furthermore, filmic grade pressure sensitive adhesives, formulated for use on synthetic film substrates, available from H.B. Fuller Co. in St. Paul, Minn., may also be employed. Such pressure sensitive adhesives grades are known to those of ordinary skill in the art.

These pressure sensitive adhesives may be formed from a variety of different types of adhesive compositions including, but not limited to, hot melt adhesives; water based adhesives; solvent-based adhesives; and reactive or thermosetting adhesives including hot melt moisture cures, one and two part thermosetting adhesives such as moisture cures including one part and two part polyurethane moisture cures, heat curable polyurethanes, one and two part epoxies, polysulfides, cyanoacrylates, radiation curable adhesives such as UV curable adhesives and electron or e-beam curable adhesives, etc. This list is intended for illustrative purposes only, and not as a limitation on the scope of the present invention.

As used herein, the term thermoset shall refer to those adhesive compositions which cure or crosslink by either heat or by chemical means.

The pressure sensitive adhesive may be formed from any suitable composition.

Solvent based adhesives are not as desirable for use due to the use of solvent and emissions volatile organic compounds as water-based adhesives wherein water is used as the carrier or hot melt adhesives which are 100% solids systems.

Solvent based adhesives may be based on polychloroprene, polyurethane, natural rubber, etc.

In a typical hot melt pressure sensitive adhesive, the adhesive may include at least one first polymer, at least one first tackifying resin, and at least one plasticizing agent.

A block copolymer may be included in the permanent grade pressure sensitive adhesive composition. Block polymers useful include ABA structures, AB structures, (A-B)ₙ radial polymers, as well as branched and grafted materials. Examples include those block copolymers having A blocks or endblocks of styrene and B blocks or midblocks of butadiene, ethylene/butylene, ethylene/propylene, isoprene, isobutylene, etc. Such block copolymers are useful from about 5 wt-% to about 60 wt-%, and more suitably about 10 wt-% to about 50 wt-%.

Mixtures of block copolymers may also be employed, or mixtures of block copolymers in combination with other types of polymer materials.

Any suitable tackifying resin or mixtures of tackifying resins may be employed herein. Examples of suitable tackifying resins include, but are not limited to, aromatic, aliphatic and cycloaliphatic hydrocarbons, modified hydrocarbons and hydrogenated versions thereof; terpenes, modified terpenes and hydrogenated versions thereof and rosins, modified rosins and hydrogenated versions thereof; and mixtures thereof. These tackifying resins are generally commercially available with differing levels of hydrogenation.

Specific examples of suitable hydrocarbon based tackifying resins include, but are not limited to, partially hydrogenated cycloaliphatic petroleum hydrocarbon resins available from Eastman Chemical Co. in Kingsport, Tenn. under the tradename of Eastotaci®, from ExxonMobil in Houston, Tex. under the tradename of Escorez® and from Hercules Specialty Chemical Co. in Wilmington, Del. under the tradename of Hercolite®; hydrogenated cycloaliphatic petroleum hydrocarbon resins including Escorez® 5000 available from ExxonMobil; partially hydrogenated aromatic modified petroleum hydrocarbon resins available from ExxonMobil under the tradename of Escorez®; hydrogenated aromatic hydrocarbon resins such as Regalrez® and Regalite® resins from Hercules Specialty Chemicals; aliphatic/aromatic petroleum hydrocarbon resins available from Goodyear Chemical Co. in Akron, Ohio under the tradename of Wingtack® Extra; an aromatic modified synthetic polyterpene hydrocarbon resin available under the tradename of Wingtack® 86; a synthetic polyterpene available under the tradename of Wingtack® 95; styrenated terpenes available from Arizona Chemical Co. in Panama City, Fla. under the tradename of Zonatac®; hydrogenated C₉ and/or C₅ resins such as Arkon® P70, P90, P115, P125 supplied by Arakawa Chemical, etc.

Useful rosins and modified rosins such as glycerol rosin esters include those available from Arizona Chemical Co. under the tradename of Sylvatac® Zonester® and pentaerythritol rosin esters available from Hercules Specialty Chemicals under the tradename of Permalyn®. It should be noted that there are numerous types of rosins and modified rosins with differing levels of hydrogenation including gum rosins, wood rosins, tall-oil rosins, distilled rosins, dimerized rosins and polymerized rosins, etc. Some specific modified rosins include glycerol and pentaerythritol esters of wood rosins and tall-oil rosins.

Alphamethyl styrene resins are available from Hercules in Wilmington, Del. under the tradename of Kristalex®.

These lists are intended for illustrative purposes only, and not as a limitation on the scope of the present invention.

Tackifying resins or mixtures thereof are useful from about 10% to about 70%, and more suitably about 20% to about 60% by weight of the adhesive composition.

Examples of suitable plasticizers include, but are not limited to, Calsol® 5120, a naphthenic petroleum based oil available from Calumet Lubricants Co. in Indianapolis, Ind. and Kaydol® White Mineral Oil, a paraffinic mineral oil available from Witco Corp. in New York, N.Y. Any generic 500 second or 1200 second naphthenic process oils would also be useful. These plasticizers are useful in amounts of from about 5% to about 60% by weight of the adhesive, suitably from about 10% to about 50% by weight of the adhesive, more suitably from about 15% to about 40% by weight of the adhesive composition.

Other liquid ingredients include liquid elastomers such as polybutene and polyisobutylene as well as liquid tackifying resins such as liquid rosin esters and liquid hydrocarbon resins. Typically, these optional liquid ingredients are not employed in amounts of more than about 20% by weight, and even more typically in amounts of not more than about 10% by weight of the adhesive composition.

Other non-elastomeric polymer materials such as other block copolymers, and homopolymers, copolymers and terpolymers of polyolefins including polyethylene or polypropylene, or modified polyolefins such ethylene vinyl acetate, ethylene n-butyl acrylate, ethylene (meth)acrylate, etc., and interpolymers of ethylene and at least one alphaolefin having from 3 to 20 carbon atoms, etc., may also be incorporated into the adhesive composition in amounts which do not adversely affect the pressure sensitivity of the adhesive composition.

Combinations of any of the above listed materials may be employed herein.

The above lists are intended for illustrative purposes only and not as a limitation on the scope of the present invention.

Other optional ingredients may also be incorporated into such compositions including, but not limited to, antioxidants, ultraviolet stabilizers, fungicides, bactericides, biocides, preservatives, perfumes, humectants, colorants, antistatic agents, waxes, and the like. These optional ingredients are known to those of skill in the art. Typically, hot melt pressure sensitive adhesives will include at least one antioxidant or a blend of antioxidants.

Water based adhesives may include at least one polymer. The polymers suitable for use in the water-based pressure sensitive adhesive include, but are not limited to, vinyl acetate polymers such as polyvinyl acetate (PVA), ethylene vinyl acetate (EVA), and vinyl acetate-ethylenes (VAEs); polyacrylics; polyurethanes; polyurethane-acrylic hybrids; polyamides; styrene-butadiene rubber; carboxylated styrene-butadiene rubber; polychoroprenes; acrylonitrile-butadiene-styrene; polyisoprene; polyisobutylene; polyurea; natural latex; polysaccharides; gum resins; etc. and mixtures thereof. Suitable other copolymers and terpolymers of such polymers, not specifically described herein, may also be employed. Of course, some polymers are more suitable than others in formulating pressure sensitive adhesives.

Polyacrylics include pure acrylics as well as styrene acrylics and vinyl acrylics, for example. More specifically, polyacrylic dispersions include, but are not limited to, styrene-acrylic, vinyl-acrylic, vinylester/vinylacetate/acrylic, etc. and combinations thereof.

Water-based adhesive compositions, in addition to the polymer(s), may also include at least one tackifying resin and at least one plasticizer. The composition, based on 100 parts polymer, may also include about 5-50 parts of a tackifying resin, more suitably about 10 to about 40 parts tackifying resin and about 1 to about 30 parts plasticizer, more suitably about 5 to about 20 parts plasticizer.

The plasticizers suitable for use in the water-based compositions include, but are not limited to, polyglycol ethers, polyethylene oxides, phosphate esters, aliphatic carboxylic acid esters, aromatic carboxylic acid esters, benzoic esters, sulfonamides, etc, and combinations thereof.

Examples of suitable tackifying resins include, but are not limited to, terpene phenolics, rosins, rosin esters, esters of hydrogenated rosins, synthetic hydrocarbon resins, etc. and combinations thereof.

Depending on the polymer system employed, cross-linkers, coupling agents, polymerization initiators, catalysts, etc., may also be optionally added.

The above lists are intended for illustrative purposes only and are not intended to limit the scope of the present invention. Combinations of any of the above materials may also be employed herein.

Water-based compositions also include a variety of other optional ingredients including, but not limited to, antioxidants, thickeners, driers, wet strength additives, surfactants, defoamers, leveling agents or flattening agents, wetting agents, colorants, pigments, UV absorbers, UV scavengers, coupling agents, adhesion promoters, fillers, biocides (antimicrobial agents), preservatives, solvents, etc. and combinations thereof. Such optional ingredients are known to those of ordinary skill in the art.

One part thermosetting compositions include, but are not limited to, cyanoacrylates, epoxies, polyurethanes, etc.

Two part thermosetting compositions include, but are not limited to, epoxies, polyurethanes, acrylics, silicones, etc.

Examples of UV cures include, but are not limited to, acrylics, silicones, urethanes/acrylic blends, cyanoacrylates, etc.

Examples of moisture cures include, but are not limited to, silicones and polyurethane moisture cures.

The above lists are not exhaustive and are intended for illustrative purposes only, and do not limit the scope of the present invention.

These adhesives are-well known to one of ordinary skill in the art. Such adhesives are intended for illustrative purposes only and not as a limitation on the scope of the present invention.

Tie layers or other treatments to improve adhesive between the adhesive and the substrate(s), may also be employed as well.

The self-adhering layer may be a magnetic layer as well. Magnetic layers useful herein include those which are water or solvent born, as well as hot melt magnetic layers. Hot melt magnetic layers are disclosed in commonly assigned U.S. Patent Publication No. US 2002-0081446 A1, the entire content of which is incorporated by reference herein. Suitably, the hot melt magnetic composition includes about 5 wt-% to about 30 wt-% polymer composition and about 70 wt-% to about 95 wt-% magnetic material, more suitably about 5 wt-% to about 25 wt-% polymer composition and about 75 wt-% to about 95 wt-% magnetic material, and even more suitably about 5 wt-% to about 20 wt-% polymer composition and about 80 wt-% to about 95 wt-% magnetic material, and most suitably about 5 wt-% to about 15 wt-% polymer composition and about 85 wt-% to about 95 wt-% magnetic material.

One method of applying the magnetic layer may include using extrusion and slot die coating techniques. Another method employs rollers. An example of this type of method is described in U.S. Pat. No. 6,881,450, the entire content of which is incorporated by reference herein in its entirety. Another method is described in WO 2004/0009370, the entire content of which is incorporated by reference herein in its entirety.

The magnetic layer is suitably about 50 microns to about 800 microns thick, more suitably about 50 microns to about 500 microns thick and even more suitably about 50 microns to about 300 microns thick.

Any suitable binder may be employed for the magnetic layer including, but not limited to, polyolefins including polyethylene and polypropylene and copolymers and terpolymers thereof; block copolymer elastomers such as those having ABA or AB structure wherein the A blocks are styrene and the B blocks are ethylene/propylene, ethylene/butylene, butadiene, isoprene, isobutylene, etc.; polyamides; polyethers; polyesters and copolyesters; polyurethanes; polyimides; etc. and suitably copolymers and terpolymers thereof. Mixtures of binders may be employed as well. Such binders are known to those of skill in the art.

The binder composition may also include other optional components such as tackifying resins, plasticizers, waxes, antioxidants, and other optional ingredients which are known to those of skill in the art.

The radiation sensitive composition may include any suitable compound which undergoes a detectable change upon exposure to high energy radiation. Some compounds may be employed because their molecular structure undergoes variation and modification when exposed to high energy radiation such as nuclear radiation. Alanine is one type of compound which undergoes such a structural change.

Compounds which undergo optical change may be employed herein. Such materials undergo changes in refractive index upon exposure to high energy radiation such as gamma radiation.

Radiation-sensitive dyes or pigments may be employed herein. Some radiation sensitive dyes or pigments undergo a color change upon exposure to high energy radiation. One example of a suitable dye is ere triphenyl-methyl-cyanide.

U.S. Pat. No. 4,791,155, discloses radiation indicators utilizing acid-sensitive dyes to monitor the radiation, the entire content of which is incorporated by reference herein.

Another example includes diacetylenes which react and undergo a color change upon exposure to gamma ray irradiation, that is, they undergo a color change indicating polymerization. Another example include the carbazolyl diacetylenes and their derivatives. See U.S. Pat. No. 4,125,534, the entire content of which is incorporated by reference herein.

Acetylenic compounds including polyacetylenes having at least two conjugated C═C bonds can be employed. See U.S. Pat. No. 4,389,217, the entire content of which is incorporated by reference herein.

The above examples are intended for illustrative purposes only, and not as a limitation on the scope of the present invention.

The label may further be optionally provided with a transparent protective film and/or other coating (not shown) such as a varnish for protection from physical damage and from the elements. This film and/or coating may be disposed over the radiation sensitive coating and first substrate, for example.

Other optional features may also be incorporated into the label assemblies according to the invention, such as tamper indicating devices.

One example of a tamper evident device is to provide a grid or mat of aligned microfibers which, upon disturbance, become disrupted to indicate tampering. A permanent grade pressure sensitive adhesive coating may be applied to this grid or mat.

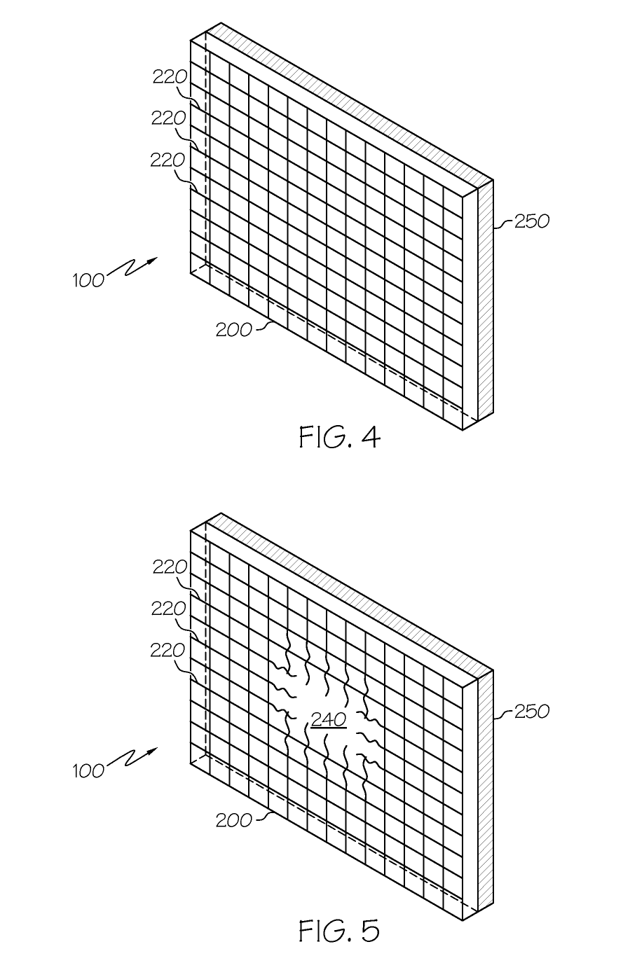

FIG. 4 illustrates an embodiment an alternative embodiment of a label assembly 100 wherein a grid or mat of aligned microfibers 220 is shown encompassed by a tacky adhesive layer 200. Suitably, the mat is embedded within the tacky adhesive layer 200, such that the adhesive layer may adhered to any desirable surface without any interference from the fiber mat 220. The adhesive is shown disposed on a substrate layer 250. The radiation sensitive composition (not shown) may be disposed on the opposite surface of the substrate layer 250. The tacky adhesive layer 200 with the grid of microfibers 220 embedded therein, may further have a release liner (not shown) disposed thereon until the label assembly 100 is used.

If the label is tampered with, the grid of microfibers 220, may be disrupted, therefore showing tampering with the label. The label assembly is shown in FIG. 5 after tampering illustrating grid of microfibers 220 broken.

The grid of microfibers is suitably embedded within the adhesive layer. This may be accomplished by coating either side of the grid, or by spraying, dipping, etc., providing that the grid is completely encompassed by the adhesive layer. Alternatively, the grid may be provided with an adhesive on one side, bonded to a surface of the substrate layer, and a tacky pressure sensitive adhesive composition applied to the other side of the grid, this surface opposite to that which is adhered to the substrate layer. The adhesive compositions may be the same or different in this embodiment.

Optionally, the label assembly may be thermally sensitive wherein a color change occurs upon the addition of body heat from attempting to remove the label, as a means of providing tamper indicating means to the label.

Optionally, authenticating indicia or features for providing proof of a genuine label which has not been counterfeited or falsified, may be added. One means of adding such a feature is to provide microtaggants in the adhesive layer. Another alternative method may be to add a printed hologram to provide a visual indicator of a non-counterfeit label.

The label may also be optionally provided with an RFID insert which is triggered by a radiation sensor when the label is exposed to high energy radiation. The RFID insert further sends out a signal indicating radiation exposure.

Furthermore, the present invention contemplates both passive and active embodiments. As is commonly understood, the passive embodiment does not have an internal power supply. In the passive embodiment, the power required to transmit back after receiving a signal is acquired through the initiating signal. The active embodiment, however, includes an internal power supply to provide power to the active components. This power supply allows the active embodiment to transmit further than its passive counterpart. Although the passive and active embodiments are often not in the same device, the present invention contemplates a device containing both, thereby providing the passive embodiment as a back-up to the active embodiment in case of a power interruption.

Both the passive or active embodiments may have a chip encoded with identifying information. The passive embodiment can be remotely interrogated by a scanning device such that the information encoded is compared to the known original code. If the two do not match exactly, the chip has been exposed and its information has been altered or corrupted, possibly from exposure to radiation or EMP. Unlike the passive embodiment, the active embodiment broadcasts the encoded information to a receiver. The receiver then compares the encoded information to a code stored in its memory. If the two no longer match exactly, the chip has been exposed and its information altered or corrupted.

The above disclosure is intended to be illustrative and not exhaustive. This description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. A label assembly for the detection of high energy radiation, the assembly comprising:
at least one substrate layer having a first surface and a second surface opposite the first surface;
at least one self-adhering layer disposed on said first surface of said substrate layer; and
at least one indicator for exposure to high energy radiation.

2. The label assembly of claim 1 wherein said indicator for high energy radiation detects alpha, beta, gamma, neutrons and hard x-rays.

3. The label assembly of claim 1 wherein said at least one self-adhering layer is formed of a pressure sensitive adhesive composition.

4. The label assembly of claim 3 wherein said at least one pressure sensitive adhesive composition is a permanent grade pressure sensitive adhesive composition.

5. The label assembly of claim 3 wherein said pressure sensitive adhesive composition is selected from the group consisting of hot melt, water-based, solvent based, thermosetting and radiation curing adhesives.

6. The label assembly of claim 3 wherein the self-adhering layer further comprises a grid of microfibers, the grid of microfibers embedded therein.

7. The label assembly of claim 3 further comprising a polymer layer, the polymer layer disposed between said at least one pressure sensitive adhesive layer and at least one substrate layer, the polymer layer comprising said at least one indicator for exposure to high energy radiation.

8. The label assembly of claim 1 wherein said at least one self-adhering layer is formed of a magnetic composition.

9. The label assembly of claim 1 further comprising a coating layer, the coating layer disposed on said second surface of said at least one substrate layer and said coating layer comprising said at least one indicator for exposure to high energy radiation.

10. The label assembly of claim 8 wherein said coating layer is disposed on said at least one substrate layer on a surface of said substrate layer which is opposite that on which said at least one pressure sensitive adhesive layer is disposed.

11. The label assembly of claim 1 wherein the at least one pressure sensitive adhesive comprises said at least one indicator for exposure to high energy radiation.

12. The label assembly of claim 1 wherein said at least one substrate layer is comprised of a polymer composition, said polymer composition comprising said at least one indicator for exposure to high energy radiation.

13. The label assembly of claim 1 further comprising indicia for authentication.

14. The label assembly of claim 13 wherein said indicia is a hologram.

15. The label assembly of claim 13 wherein said indicia comprises microtaggants.

16. The label assembly of claim 1 further comprising radio frequency identification.

17. The label assembly of claim 17 wherein said radio frequency identification is passive or active.

18. A pressure sensitive adhesive label for detection of high energy radiation, the pressure sensitive adhesive label comprising:
at least one substrate layer;
at least one pressures sensitive adhesive layer;
at least one coating comprising an indicator for exposure to high energy radiation; and
radio frequency identification.

19. The pressure sensitive adhesive label of claim 18 wherein said radio frequency identification is active or passive.

20. A method for detecting high energy radiation, the method comprising the steps of:
providing a label assembly, the label assembly comprising at least one adhesive layer and at least one composition for detecting high energy radiation provided on said label assembly, and at least one device for transmitting acknowledgement of said detection of said high energy radiation;
adhering said label assembly to a surface; and
wherein upon exposure to high energy radiation, the composition detects said high energy radiation and a signal is broadcast.
